(19) United States
(12) Patent Application Publication
(10) Pub. No.: US 2014/0082376 A1
(43) Pub. Date: Mar. 20, 2014

(54) System, Method and Apparatus for Securely Saving/Retrieving Data on a Data Storage

(71) Applicant: Texas Tech University System, Lubbock, TX (US)

(72) Inventors: Timothy E. Roden, Beaumont, TX (US); Mathew Gray, San Angelo, TX (US); Andy Wallace, San Angelo, TX (US)

(73) Assignee: Texas Tech University System, Lubbock, TX (US)

(21) Appl. No.: 14/026,119

(22) Filed: Sep. 13, 2013

Related U.S. Application Data
(60) Provisional application No. 61/701,526, filed on Sep. 14, 2012.

(51) Int. Cl. G06F 21/60

(52) U.S. Cl. CPC G06F 21/602
USPC 713/193

(57) ABSTRACT

A system, method and apparatus securely save data by receiving a file from a user device, wherein the file contains an encrypted data and has a file name. The encrypted data is then split into two or more encrypted data chunks having a specified size. A chunk number is assigned to each of the two or more encrypted data chunks. Each of the two or more encrypted data chunks is saved in a chunk file having a chunk file name comprising a combination of the file name and the chunk number. Each chunk file name is then encrypted, and each chunk file having the encrypted chunk file name is sent to the data storage. The process is essentially reversed to retrieve the data.

### CROSS-REFERENCE TO RELATED APPLICATIONS

This Non-Provisional patent application claims priority to U.S. Provisional Patent Application Ser. No. 61/701,526, filed Sep. 14, 2012, entitled “System, Method and Apparatus for Securely Saving/Retrieving Data on a Data Storage,” the contents of which is incorporated by reference herein in its entirety.

### FIELD OF THE INVENTION

The present invention relates generally to the field of information technology and, more particularly, to a system and method for securely saving data on a data storage.

### STATEMENT OF FEDERALLY FUNDED RESEARCH

None.

### BACKGROUND OF THE INVENTION

Many cloud-based storage services only encrypt data after it is received. Although the encryption/decryption keys are supposed to be protected, the data and encryption keys are vulnerable. In addition, some cloud-based storage services mine the data for their own use before it is encrypted. As a result, relying on the cloud-based storage service provider to encrypt a user's data does not guarantee protection of the data.

Accordingly there is a need for a system, method and apparatus for securely saving/retrieving data on a data storage.

### SUMMARY OF THE INVENTION

The present invention provides method for securely saving data by receiving a file from a user device, wherein the file contains an encrypted data and has a file name. The encrypted data is then split into two or more encrypted data chunks having a specified size. A chunk number is assigned to each of the two or more encrypted data chunks. Each of the two or more encrypted data chunks is saved in a chunk file having a chunk file name comprising a combination of the file name and the chunk number. Each chunk file name is then encrypted, and each chunk file having the encrypted chunk file name is sent to the data storage.

In addition, the present invention provides a method for securely retrieving data by receiving a request for a file from a user device, wherein the file contains an encrypted data and has a file name. Two or more chunk file names associated with the file are then retrieved and each chunk file name is encrypted. Each chunk file is retrieved using the encrypted chunk file names from the data storage, wherein each chunk file contains an encrypted data chunk having a specified size. The encrypted data chunks are combined into the file having the file name and the file is sent to the user device.

Moreover, the present invention provides an apparatus for securely saving a data on a data storage that includes one or more interfaces and one or more processors communicably coupled to the one or more interfaces. The one or more processors: receive a file from a user device via the one or more communication interfaces, wherein the file contains an encrypted data and has a file name; split the encrypted data into two or more encrypted data chunks having a specified size; assign a chunk number to each of the two or more encrypted data chunks; save each of the two or more encrypted data chunks in a chunk file having a chunk file name comprising a combination of the file name and the chunk number; encrypt each chunk file name; and send each chunk file having the encrypted chunk file name to the data storage via the one or more interfaces.

Furthermore, the present invention provides an apparatus for retrieving a data on a data storage that includes one or more interfaces, and one or more processors communicably coupled to the one or more interfaces. The one or more processors: receive a request for a file from a user device via the one or more communication interfaces, wherein the file contains an encrypted data and has a file name; retrieve two or more chunk file names associated with the file; encrypt each chunk file name; retrieve each chunk file using the encrypted chunk file names from the data storage via the one or more interfaces, wherein each chunk file contains an encrypted data chunk having a specified size; combine the encrypted data chunks into the file having the file name; and send the file to the user device via the one or more communication interfaces.

The present invention also provides a system for securely saving a data that includes one or more user devices, a data storage, one or more networks and a server device communicably coupled to the one or more user devices and the data storage via the one or more networks. The server device: receives a file from the one or more user devices, wherein the file contains an encrypted data and has a file name; splits the encrypted data into two or more encrypted data chunks having a specified size; assigns a chunk number to each of the two or more encrypted data chunks; saves each of the two or more encrypted data chunks in a chunk file having a chunk file name comprising a combination of the file name and the chunk number; encrypts each chunk file name; and sends each chunk file having the encrypted chunk file name to the data storage.

In addition, the present invention provides a system for securely retrieving a data that includes one or more user devices, a data storage, one or more networks and a server device communicably coupled to the one or more user devices and the data storage via the one or more networks. The server device: receives a request for a file from a user device, wherein the file contains an encrypted data and has a file name; retrieves two or more chunk file names associated with the file; encrypts each chunk file name; retrieves each chunk file using the encrypted chunk file names from the data storage, wherein each chunk file contains an encrypted data chunk having a specified size; combines the encrypted data chunks into the file having the file name; and sends the file to the user device via the one or more communication interfaces.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a block diagram of a secure data storage/retrieval system and apparatus in accordance with one embodiment of the present invention;

FIGS. 2A-2B are flow charts illustrating a method for securely storing a data file using the user device (FIG. 2A) and the server device (FIG. 2B) in accordance with one embodiment of the present invention;

FIGS. 3A-3B are flow charts illustrating a method for securely retrieving a data file using the server device (FIG. 3A) and the user device (FIG. 3B) in accordance with one embodiment of the present invention;

FIG. 4 is a flow chart illustrating a method for securely storing a data file using the user device and the server device in accordance with another embodiment of the present invention; and

FIG. 5 is a flow chart illustrating the functions used to securely store/retrieve a data file using the user device and the server device in accordance with another embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The discussion herein relates primarily to securely saving data to the cloud, but it will be understood that the concepts of the present invention are applicable to securely storing data on any local, network or remote storage. Moreover, the discussion relates to examples using devices and software using the Windows operating system, but it will be understood that the concepts of the present invention are applicable to other types of operating systems and other technologies developed in the future.

The present invention's file-by-file encryption, key creation and management system directly addresses this primary impediment to enterprise use of cloud-based computing. It is a technology that will, for the first time enable organizations to make the cloud private, safe and compliant and a key component of their future IT strategy. The present invention's technology allows enterprises to secure data before it leaves the organization premise and remain stored in the cloud safely and securely until needed by the organization. The technology is being packaged in a software development kit (SDK) that will be used by application developers and those building network appliances who need to offer secure and compliant cloud-based solutions to grow their businesses.

The present invention, also referred to as RamCloud, provides many benefits, such as file-by-file security encryption before sending the data to the cloud, assignment of individual keys to each piece of data for greater security, individual access to files, elimination of third party and cloud provider access to the data, verification through a third party technology audit, and helping to support requirements of HIPPA, GLBA, and FERPA. The present invention's encryption technology generates a total key by combining a user key and a dynamic variable key through the SHA256 algorithm. Other encryption algorithms and security key lengths can be used. Note that the present invention uses metadata to generate the dynamic variable key, which is destroyed once the data is encrypted. As a result, the terms key, encryption key, decryption key and security key include the use of metadata to encrypt and decrypt the data.

The present invention uses a file-by-file encryption technology to secure data by using a user key and a dynamic variable that are combined together to form a total key. The user key is unique to each user and can be rotated if necessary. The user key is generated by the RamCloud server. The dynamic variable is computed from the file/data that is being encrypted and is saved as meta-data about the file. The total key is generated by running a combination of the User Key and Dynamic Variable through the SHA256 Algorithm (Secure Hash Algorithm) or other suitable encryption algorithm. The total key is 32 bytes in length (256 bits) and is a perfect match for AES256 (Advanced Encryption Standard). Other key lengths can be used. The total key is discarded after being used with the file. The total key is never saved. When the file is downloaded, the total key will be regenerated from the User Key and Dynamic Variable.

The data is compressed before it is encrypted. This step is recommended, but not required, to reduce the file's size and save the end user storage space. One example of a suitable compression technique is GNU zip. Other compression techniques can be used. The total key is used in AES256 to encrypt all the data before it is transferred to a RamCloud Server.

Once the data is encrypted, the encrypted data is chunked. Two things happen during chunking First, the file is broken into 64 KB chunks and each is given a chunk name in order from 1 to n, where n is the number of chunks the file was broken into. An example would be myfile.txt1, myfile.txt2, myfile.txt3, . . . myfile.txt15. Other file chunk sizes can be used. Second, the filename is encrypted with a generic one-way algorithm and used as that chunk's name. An example filename might look like “—x1d=Avc-56”.

Retrieving the file from the cloud happens in the exact reverse order of uploading one to it. The chunk names are regenerated from the filename and then pulled from the cloud. The data is decrypted, then decompressed and saved to a Downloads folder on the clients system.

With respect to performance of the present invention, encryption/decryption adds nothing significant in terms of access time for cloud files. The relationship between the file size and access time is linear. For example, a file twice as large as a smaller file requires approximately twice as much time to encrypt and decrypt as the smaller file, and so on. So, the overhead per file is basically a constant amount and that amount is in the milliseconds. Overall, it's a nonissue when compared with other encryption methods, which is to say that the performance is on par with other encryption methods and there is no way to speed it up relative to other methods. Sample file processing times are shown below.

| Android | Average | PC | Average | |
|---|---|---|---|---|
| 100 kb | 8.6 ms | 100k | 182 | ms |
| 1 mb | 88.6 ms | 1 mb | 208.3 | ms |
| 10 mb | 516 ms | 10 mb | 328 | ms |

The RamCloud SDK allows an application developer to read/write files securely in cloud storage. In order to keep the SDK generic enough to adapt to the large variety of architectures, there is no built-in recovery mechanism. The application developer would build in the specific mechanism they want to use with their architecture.

Since the architecture and access needs may vary greatly from one entity to another, granting access to multiple users would be something the application developer would do to ‘extend’ the SDK. This gives the application developer the flexibility to design a scheme that meets the entity's specific needs.

The present invention does not add any additional performance burden, beyond what a traditional single-key encryption algorithm would see. The overhead associated with throwing away the keys and recreating them as the file comes back from the cloud is less than 100 bytes per file.

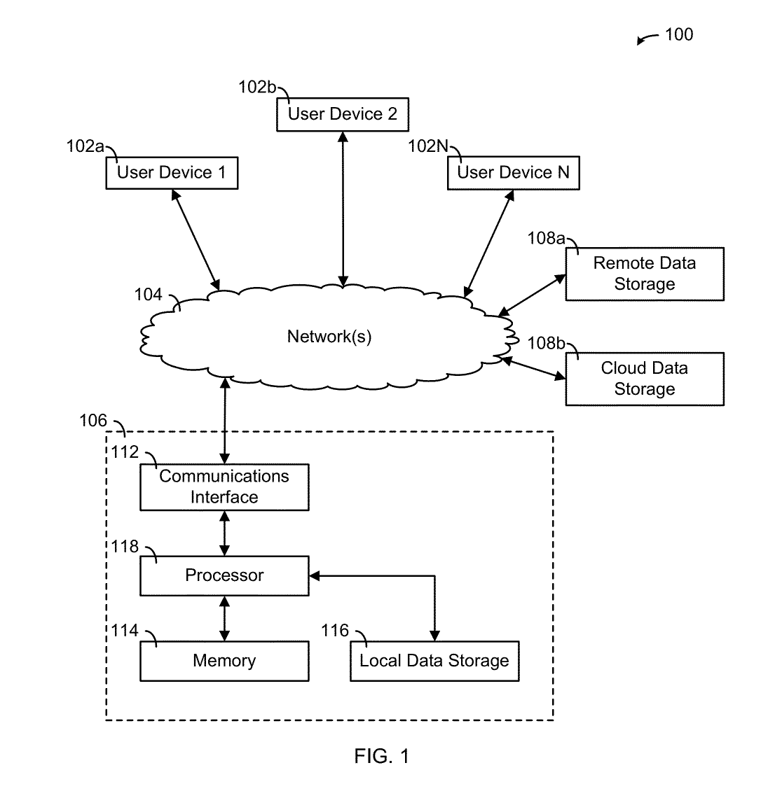

Referring now to FIG. 1, a block diagram of a secure data storage/retrieval system 100 and apparatus 106 in accordance with one embodiment of the present invention is shown. The system 100 includes one or more user devices 102 (e.g., User Device 1—102a, User Device 2—102b, User Device N—102N), one or more communication networks 104 and a server device 106. Each user device 102 communicates with the one or more communication networks 104 using a mobile phone, a mobile computing device, a computer, a workstation, a laptop, a tablet, a handheld computing device, a handheld communications device, a personal data assistant, an entertainment device, a data storage device, or any other device in which user can send/receive data to/from the server device 106. The one or more communications networks 104 may include a local area network, a wide area network, a hardline connection, a wireless connection, a satellite connection, a point-to-point connection, the Internet, a private network, a service provider's network, any other means of transmitting data, or any combination thereof. The data storage 108 can be a remote data storage device 108a, a network data storage device or a cloud data storage server 108b (e.g., Amazon Web Services (“AWS”)).

The server device 106 includes a communications interface 112, a memory 114, one or more databases 116, and one or more processors 118. The communications interface 112 is communicably coupled to the one or more user devices 102 and the one or more data storages 108 via the one or more communication networks 104. The communications interface 112 can be multiple interfaces and will typically include secure connections using SSL. The processor 118 is communicably coupled to the communications interface 112, the memory 114 and the local data storage 116. Note that the present invention may include redundant devices or devices operating in parallel.

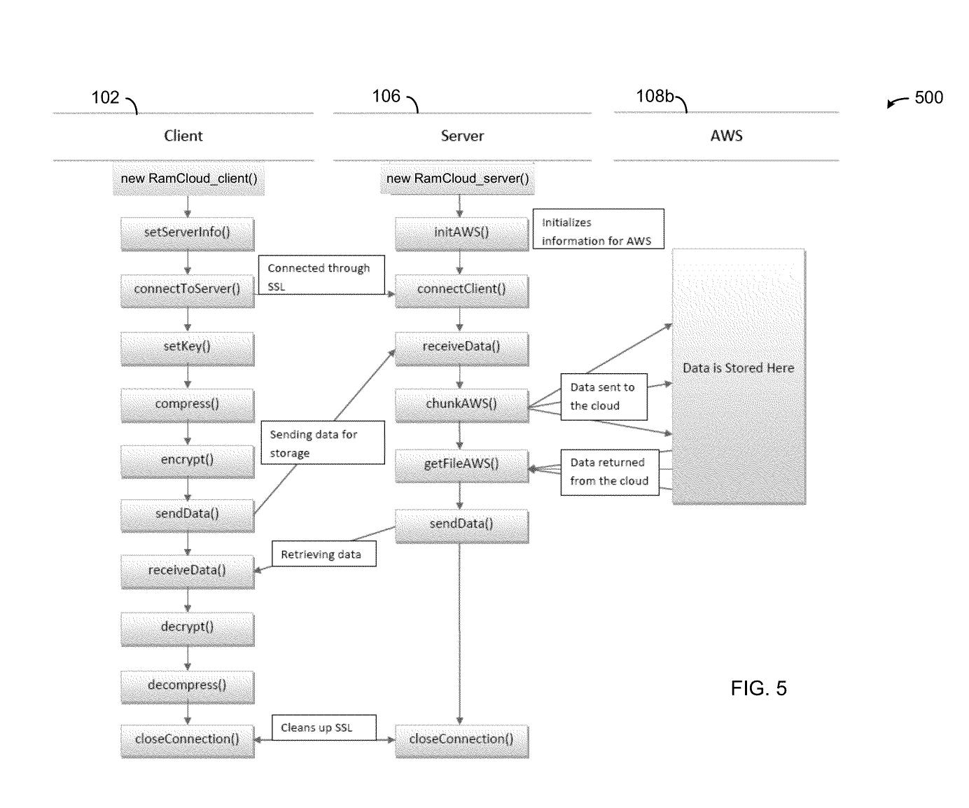

The RamCloud server is the intermediary between each client and the public cloud. It works by receiving data from each client and then storing it on the cloud to prevent the client from ever actually interacting with the cloud itself You initialize the server by calling ‘new RamCloud_server’ with the correct parameters. To establish a connection with the Amazon Web Service you must call ‘initAWS’ with your access key and your secret access key. Thereafter, the specific functions called can vary. One example is shown and will be described in reference to FIG. 5. In another embodiment, ‘loadServerData’ can be the next function call. This loads previous data into the server. Next, ‘startServer’ can be called to start the server listening on the specified port from the new call and returns the file descriptor to you. You may want to thread at this point and have those threads call ‘acceptClient’ to accept a client. The client can attempt to ‘logInUser’ or ‘createNewUser’ and the server should receive this with ‘connectUser’. The client may then attempt to send a file over to the server. ‘checkListingAvail’ can be used to see if this file is already in use or not and respond appropriately. If it is not then ‘postItem’ may be called to record the file in the records. Use your cloud services proper APIs to store the file. When retrieving a file, a call to ‘getDynVar’ will retrieve the dynamic variable so the file can be decrypted properly. Other server functions are further described below.

The RamCloud client is the main interface for end users of the product. It offers a simplistic and secure way to store data on public clouds. The client is first created by calling ‘new RamCloud_client.’ It then needs to set the information of the server it is connecting to by calling ‘setServerInfo.’ Once this is done, calling ‘connectToServer’ will connect the client to the server and file transfer can now begin. Calling ‘setKey’ creates the key that will be used for the current file. The client will then want to compress and encrypt data to reduce the amount of storage each file takes up and increase security. Using ‘sendData’ the client will tell the server that it wants to send a file to the cloud and the server will fulfill that request. To retrieve a file from the server, a request is made and the data is received through receiveData. The client then calls decrypt and decompress to get the original file back. Once the client has finished its interaction with the server it calls ‘closeConnection’ and waits for the server's response. Other client functions are further described below.

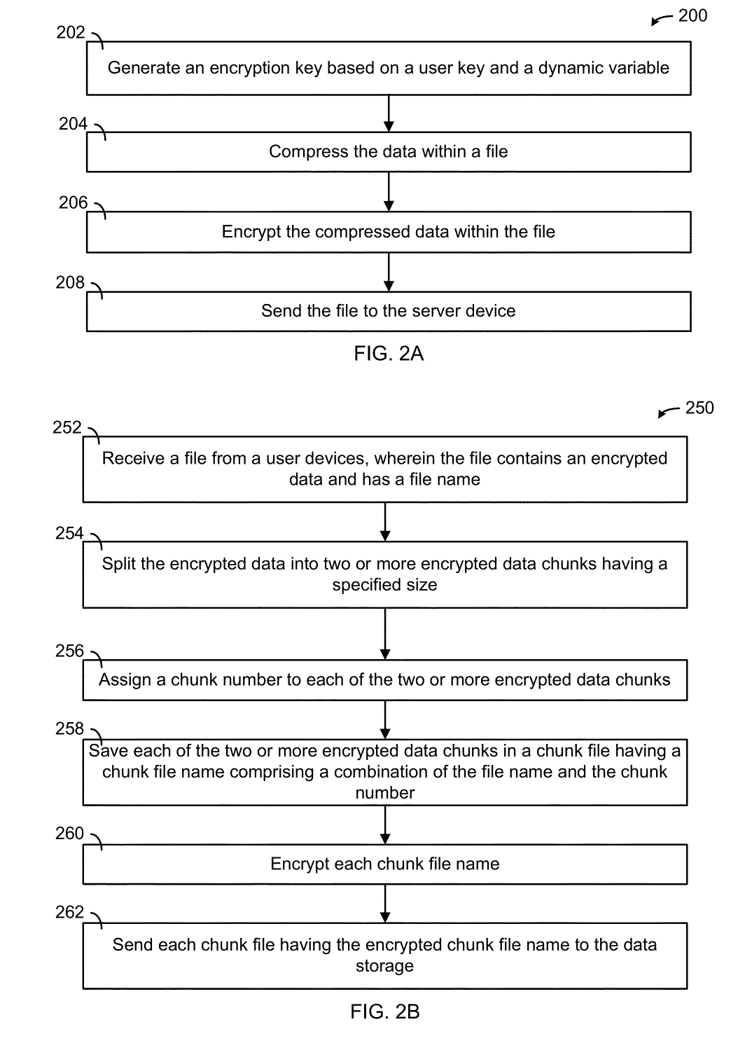

Now referring to FIGS. 2A-2B, flow charts illustrating a method for securely storing a data file using the user device 200 (FIG. 2A) and the server device 250 (FIG. 2B) in accordance with one embodiment of the present invention are shown. The user device running the RamCloud client generates an encryption key based on a user key and a dynamic variable in block 202. The user key is obtained from the server device. The dynamic variable is based on one or more characteristics of the file. The RamCloud client compresses the data within the file in block 204 and encrypts the compressed data using the encryption key in block 206. The file containing the encrypted data is then sent to the RamCloud server in block 208. The encryption/decryption key is destroyed after it is used. Additional functionality will be described below in reference to the Client SDK functions.

The RamCloud server receives a file from a user device, wherein the file contains an encrypted data and has a file name, in block 252. The RamCloud server then splits the encrypted data into two or more encrypted data chunks having a specified size (e.g., 64 KB) in block 254. A chunk number is assigned to each of the two or more encrypted data chunks in block 256. Each of the two or more encrypted data chunks are saved in a chunk file having a chunk file name comprising a combination of the file name and the chunk number in block 258. Each chunk file name is then encrypted in block 260, and each chunk file having the encrypted chunk file name is sent to the data storage in block 262.

The RamCloud server may also generate the encryption key for the user device or a user of the user device, and provide the encryption key to the user device. The RamCloud server may also save a meta data (e.g., a length of the received file) about the received file. Other steps may include initializing the server device using one or more parameters, accepting a secure connection from the user device via the one or more interfaces, establishing a connection with the data storage via the one or more interfaces, creating an account for a user, receiving a login data from the user device, authenticating the login data, determining whether another file having the file name has been received, and sending a message to the user device that the file cannot be accepted because the file name has already been used. Additional functionality will be described below in reference to the Server SDK functions.

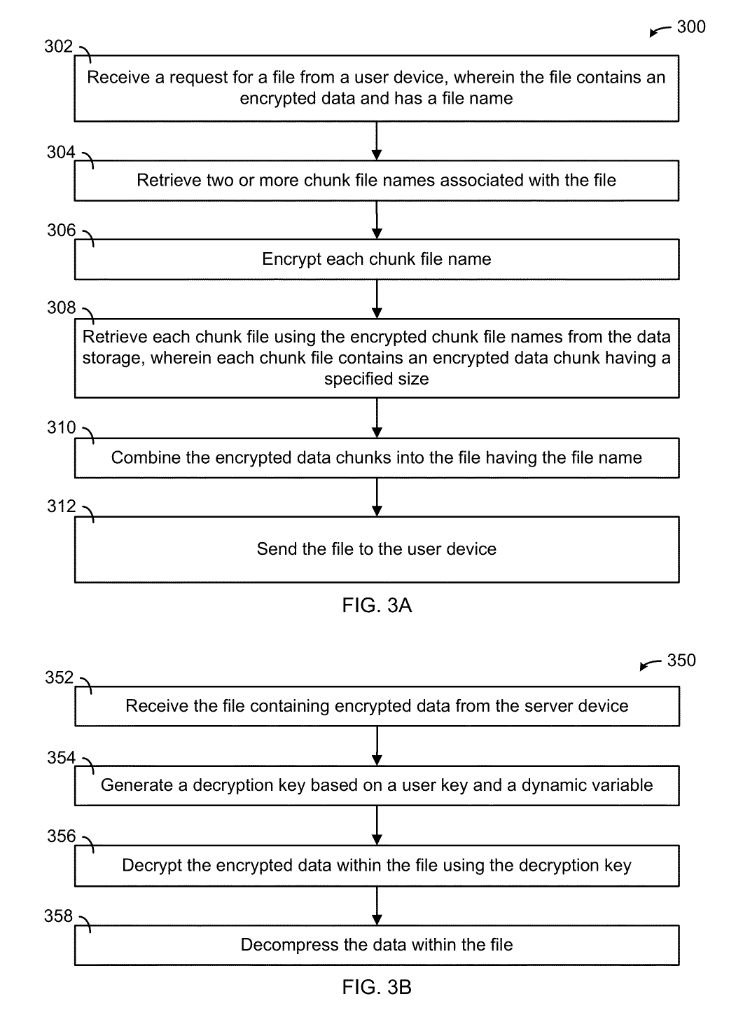

Referring now to FIGS. 3A-3B, flow charts illustrating a method for securely retrieving a data file using the server device 300 (FIG. 3A) and the user device 350 (FIG. 3B) in accordance with one embodiment of the present invention are shown. The server device running the RamCloud server receives a request for a file from a user device, wherein the file contains an encrypted data and has a file name, in block 302. The RamCloud server then retrieves two or more chunk file names associated with the file in block 304. Each chunk file name is encrypted in block 306. Each chunk file is retrieved in block 308 using the encrypted chunk file names from the data storage, wherein each chunk file contains an encrypted data chunk having a specified size (e.g., 64 KB). The encrypted data chunks are combined into the file having the file name in block 310 and the file is sent to the user device in block 312.

The RamCloud server may also retrieve a meta data (e.g., a length of the file) about the file, accept a secure connection from the user device, or establish a connection with the data storage via the one or more interfaces. Additional functionality will be described below in reference to the Server SDK functions.

The user device running the RamCloud client receives the file containing the encrypted data from the server device in block 352. The RamCloud client generates a decryption key based on a user key and a dynamic variable in block 354. The user key is obtained from the server device. The dynamic variable is based on one or more characteristics of the file. The encrypted data is decrypted using the decryption key in block 356, and the decrypted data is decompressed in block 358. The decryption key is destroyed after it is used. Additional functionality will be described below in reference to the Server SDK functions.

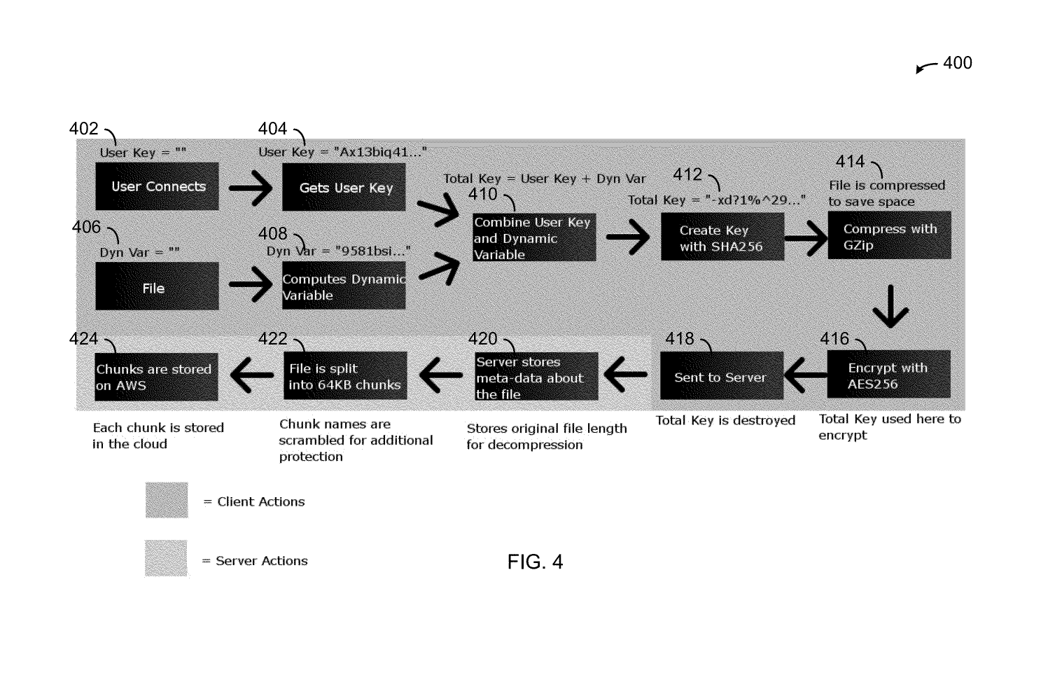

Now referring to FIG. 4, a flow chart illustrating a method 400 for securely storing a data file using the user device and the server device in accordance with another embodiment of the present invention is shown. The user device connects to the server device in block 402 and a user key is obtained in block 404. The file to be saved is shown in block 406 and a dynamic variable is computed based on the file in block 408. The user key and the dynamic variable are combined together to form a total key in block 410, and an encryption key is created from the total key in block 412. The file is compressed to save space in block 414, the compressed data is encrypted using the encryption key in block 416, and the file containing the encrypted data is sent to the server in block 418. Note that the encryption key is destroyed. The server device receives the file and stores meta data (e.g., original file length for decompression) about the file in block 420. The file is split into 64 KB chunks and the chunk names are scrambled for additional protection in block 422. The chunks are then stored in the cloud in block 424.

Referring now to FIG. 5, a flow chart 500 illustrating the functions used to securely store/retrieve a data file using the user device 102 (client) and the server device 106 (server) in accordance with another embodiment of the present invention is shown. The cloud data storage server 108b is designated as AWS. The primary functions for the client 102 and server 106 are shown. These functions are described in more detail below.

The Linux server SDK was designed to be a secure storage framework that would give a user the ability to store user keys and dynamic variables as well as retrieve them without interfering with normal server operations. Data storage can either be shipped to the cloud or contained on the local machine. The server also contains logging that can be turned on or off for audit control. All of the key management is self contained. To retrieve and store a key for users is extremely simple and requires no help from outside the SDK. The SDK uses SSL to communicate data between client and server as well as server and cloud. This creates an extremely safe environment that is still quick and responsive. Out of the box, the SDK supports the Amazon Web Service's Simple Storage Service (S3). It comes with all the functions necessary for managing the cloud storage solution and also directly implements use of these for a quick-startup in the case that you need a turn-key solution for your product. The RamCloud Server SDK was also created to be thread-safe. Amazon offers an Elastic Compute Cloud (EC2) that the SDK was tested on and functions well with. This means both the storage and the server are in the cloud. There is no high-end equipment to buy, just a small computer to talk to EC2.

Mobile devices are becoming more and more common every day. The RamCloud Android Client SDK takes advantage of this without compromising any of its functionality. Compression and encryption take place on the mobile device with great speed. Any Android device above the firmware release 2.0 will run the application. The encrypted data will be sent to the server over either Wi-Fi or your service provider's network. This allows you to store data from anywhere you have service. The client also supports decryption and decompression of files you have stored on the cloud through the SDK. All transmission of data is protected by an SSL layer to further protect its integrity. Operations on the client side are sped up through the use of the native C programming language rather than Java to make better use of the phones resources.

The Windows server SDK is a secure storage framework that will allow a user to interact seamlessly without any interfering operations. All of the key management is self-reliant, so retrieving and storing of keys is simple and requires no help from outside of the SDK. The SDK was created to be thread-safe. The server allows the use of logging which can be turned on or off as needed. The SDK uses SSL to communicate between the client and server as well as to communicate with the cloud which allows for a particularly safe environment to communicate with that is quick to respond. The SDK currently fully supports the use of Amazon Web Service's Simple Storage Service, while still being completely compatible with other cloud services. The server will allow a user to store all data locally or on a cloud. If stored on a cloud, when the server data is loaded it will decrypt all data from the cloud, with the private key created by the user. Additionally, Amazon Web Service offers an Elastic Compute Cloud (EC2) that the SDK is functionally compatible with. This allows the server to be stored on a cloud as well. The SDK comes with an implementation of these services if a user is in need of a convenient solution.

The Windows client SDK allows for simple and successful interaction with the server. The SDK uses SSL to communicate between the client and server. Which allows for a particularly safe environment to communicate with that is quick to respond. The SDK allows for easy compression and encryption for storage on a cloud as well as the decryption and decompression for retrieving data from a cloud. The SDK comes with an implementation of services that will allow a user to create new users and log in existing ones. If the user is looking for a turn-key solution, the SDK also comes with fully working functions that allow interaction with a cloud. The SDK was created to be thread-safe.

The Linux client SDK is virtually the mirror image of the Windows Client. It contains the exact same functionality; the only difference is that it uses the Linux libraries instead of the Windows libraries. Data transmission is still protected by OpenSSL, encryption is done on a file-by-file basis, and compression is still enabled. Files stored on any client are recoverable by any of the other clients. This is because each client uses the same standard for compression and encryption. This means you could upload a picture from your phone, recover it later on your computer, and then post it to your favorite social networking site.

The following description details the functions in the Server SDK for the RamCloud Product in accordance with the present invention. The Server library was developed in Windows, for Windows. Server libraries for other operating system can be developed based on the following functions. The functions used allow the transmittal of encrypted data through SSL to clients and to cloud servers for storage. The RamCloud_server function should be used before calling other functions. The functions include base functions, physical storage functions, cloud storage functions, administrative functions and readymade functions. Other functions or function types can also be used.

The Base Functions include and will now be described:

| | | | |
|---|---|---|---|
| RamCloud_server | closeConnection | decrypt | writeRecords |
| loadServerData | logEvent | sendData | getRecords |
| startServer | genKey | receiveData | getListings |
| acceptClient | getKey | sendHeader | getDynVar |
| connectUser | encrypt | receiveHeader | |

The RamCloud_server function initializes the SSL libraries and prepares the server for incoming clients:

RamCloud_server::RamCloud_server(string serverName, bool
enableLogging, int *result);

| | |
|---|---|
| Parameters: | serverName is a string which is the server name you are |
| | using, if you do not have one use “”. |
| | enableLogging is whether logging will be enabled or not. |
| | result is an integer containing the result of any errors that |
| | may have occurred. |
| Return Value: | None. |
| Example: | RamCloud_server *s; |
| | ... |
| | s = new RamCloud_server(″″,2,&res); |
| Requirements: | Include <RamCloud_server.h> |

The loadServerData function loads the server data. If cloudStored is true, the function gets the necessary information from the cloud, otherwise the information is stored locally and the function retrieves it.

int RamCloud_server::loadServerData(bool cloudStored, string data);

| | |
|---|---|
| Parameters: | cloudStored is boolean containing true if the metadata is |
| | stored in a cloud, false if it is not. |
| | data is a string containing any data to be stored, default |
| | is an empty string constant. |
| Return Value: | An integer value of any errors that may have occurred, |
| | a 0 means no error has occurred. |
| Example: | RamCloud_server *s; |
| | ... |
| | s->loadServerData(false); |
| Requirements: | Include <RamCloud_server.h> |

See also: new RamCloud_server

The startServer function starts the server and prepares the server for incoming clients.

int RamCloud_server::startServer(char * certFile, char * keyfile, SOCKET * sock,
unsigned short port);

| | |
|---|---|
| Parameters: | certFile is a character array containing the name of the file that |
| | contains your SSL certification. |
| | keyFile is a character array containing the name of the file that |
| | contains your SSL key. |
| | Sock is a socket that will point to the listen_socket. |
| | Port is an unsigned short that determines what port your server will run |
| | on. |
| Return Value: | An integer value of any errors that may have occurred, a 0 means no |
| | error has occurred. |
| Example: | RamCloud_server *s; |
| | ... |
| | int error = s->startServer(“matscert.pem”, “matskey.pem”, |
| | &listen_socket, 443); |
| Requirements: | Include <RamCloud_server.h> |

See also: new RamCloud_server

The acceptClient function accepts the socket and initializes the SSL structure.

SSL * RamCloud_server::acceptClient(SOCKET listen_sock,SSL ** ssl);

| | |
|---|---|
| Parameters: | listen_sock is the socket used to start the server. |
| | Ssl is the ssl connection that a client is connected on. |
| Return Value: | An integer value of any errors that may have occurred, a 0 |
| | means no error has occurred. |
| Example: | RamCloud_server *s; |
| | ... |
| | int ret = s->acceptClient(listen_socket,&ssl); |
| Requirements: | Include <RamCloud_server.h> |

See also: new RamCloud_server

The connectUser function responds to the client's request to either create a new user or log in an existing one. It checks and creates records as needed to complete this action.

void RamCloud_server::connectUser(SSL * ssl);

| | |
|---|---|
| Parameters: | ssl is the ssl connection that a client is connected on. |
| Return Value: | None. |
| Example: | RamCloud_server *s; |
| | ... |
| | s->connectUser(ssl); |
| Requirements: | Include <RamCloud_server.h> |

The closeConnection function closes the client's connection to the server and then frees up the SSL object.

void RamCloud_server::closeConnection(SSL * ssl);

| | |
|---|---|
| Parameters: | ssl is the ssl connection that a client is connected on. |
| Return Value: | None. |
| Example: | RamCloud_server *s; |
| | ... |
| | s->closeConnection(ssl); |
| Requirements: | Include <RamCloud_server.h> |

See also: new RamCloud_server and acceptClient

The logEvent function logs the event that is specified with a leading time stamp for auditing.

| void RamCloud_server::logEvent(string ev); | |
|---|---|
| Parameters: | ev is the event message that you want to log. |
| Return Value: | None. |
| Example: | RamCloud_server *s; |
| | ... |
| | s->logEvent(“Some event”); |
| Requirements: | Include <RamCloud_server.h> |

See also: new RamCloud_server

The genKey function is used to generate a user key for a new user and for subsequent keys if necessary. It is only called in connectUser when the connecting user is new.

| string RamCloud_server::genKey( ); | |
|---|---|
| Parameters: | None. |
| Return Value: | A string containing the new user key. |
| Example: | RamCloud_server *s; |
| | ... |
| | string key = s->genKey( ); |
| Requirements: | Include <RamCloud_server.h> |

See also: new RamCloud_server

The getKey function is used to get a user key for a user. It sends a header with the key as a string in the filename field.

void RamCloud_server::getKey(string username,SSL *ssl);

| | |
|---|---|
| Parameters: | username is a string containing the username of the |
| | current user. |
| | Ssl is the ssl connection that a client is connected on. |
| Return Value: | A string containing the user's key. |
| Example: | RamCloud_server *s; |
| | ... |
| | string user= “username”; |
| | s->getKey(user,ssl); |
| Requirements: | Include <RamCloud_server.h> |

See also: new RamCloud_server

The encrypt function is used to encrypt data.

| string RamCloud_server::encrypt(string data); | |
|---|---|
| Parameters: | data is a string of data to be encrypted. |
| Return Value: | A string containing the encrypted data. |
| Example: | RamCloud_server *s; |
| | ... |
| | string cryptedData = encrypt(data); |
| Requirements: | Include <RamCloud_server.h> |

See also: new RamCloud_server

The decrypt function is used to decrypt data.

| string RamCloud_server::decrypt(string data); | |
|---|---|
| Parameters: | data is a string of data to be decrypted. |
| Return Value: | A string containing the decrypted data. |
| Example: | RamCloud_server *s; |
| | ... |
| | string cryptedData = decrypt(data); |
| Requirements: | Include <RamCloud_server.h> |

See also: new RamCloud_server

The sendData function sends information in the data parameter to the client.

int RamCloud_server::sendData(void * data, int len, SSL * ssl);

| | |
|---|---|
| Parameters: | data is a pointer to a data structure containing information |
| | to be sent. |
| | Len is the length of the data to be sent. |
| | Ssl is the SSL connection the server wants to send to. |
| Return Value: | The number of bytes sent to the client. |
| Example: | RamCloud_server *s; |
| | ... |
| | string str = “Hello World”; |
| | s->sendData((void *)str.c_str( ), str.length( ), ssl); |
| Requirements: | Include <RamCloud_server.h> |

See also: new RamCloud_server and acceptClient

The receiveData function is used to receive information from a client.

string RamCloud_server::receiveData(SSL * ssl);

| | |
|---|---|
| Parameters: | ssl is the SSL connection the server wants to receive from. |
| Return Value: | A string containing the data received from the client. |
| Example: | RamCloud_server *s; |
| | ... |
| | string str = s->receiveData(ssl); |
| Requirements: | Include <RamCloud_server.h> |

See also: new RamCloud_server and connectClient

The sendHeader function sends information in the header parameter to the client.

int RamCloud_server::sendHeader(RamCloud_header * h, SSL * ssl);

| | |
|---|---|
| Parameters: | h is a RamCloud_header containing information to be sent. |
| | ssl is the SSL connection the server wants to send to. |
| Return Value: | The number of bytes sent to the client. |
| Example: | RamCloud_server *s; |
| | ... |
| | RamCloud_header h = new RamCloud_header( ); |
| | s->sendHeader(h,ssl); |
| Requirements: | Include <RamCloud_server.h> |

See also: new RamCloud_server and acceptClient

The receiveHeader function receives information from the client.

RamCloud_header RamCloud_server::sendData(SSL * ssl);

| | |
|---|---|
| Parameters: | ssl is the SSL connection the server wants to receive from. |
| Return Value: | The header containing the information received. |
| Example: | RamCloud_server *s; |
| | ... |
| | RamCloud_header h = new RamCloud_header( ); |
| | h = s->receiveHeader(ssl); |
| Requirements: | Include <RamCloud_server.h> |

See also: new RamCloud_server and acceptClient

The writeRecords function writes all the records of each user into a records.txt file.

void RamCloud_server::writeRecords(bool cloudStored);

| | |
|---|---|
| Parameters: | cloudStored is Boolean where if all records are stored in the |
| | cloud then cloudStored is true. |
| Return Value: | None. |
| Example: | RamCloud_server *s; |
| | ... |
| | s->writeRecords(false); |
| Requirements: | Include <RamCloud_server.h> |

See also: loadServerData

The getRecords function gets all the records stored.

Vector<RamCloud_record> RamCloud_server::getRecords( );

| | |
|---|---|
| Parameters: | None. |
| Return Value: | A vector of all the records stored. |
| Example: | RamCloud_server *s; |
| | ... |
| | Vector<RamCloud_record> v; |
| | v = s->getRecords( ); |
| Requirements: | Include <RamCloud_server.h> |

The getListings function gets all the listings stored.

| Vector<RamCloud_listing> RamCloud_server::getListings( ); | |
|---|---|
| Parameters: | None. |
| Return Value: | A vector of all the listings stored. |
| Example: | RamCloud_server *s; |
| | . . . |
| | Vector<RamCloud_listing> v; |
| | v = s->getListings( ); |
| Requirements: | Include <RamCloud_server.h> |

The getDynVar function gets the dynamic variable.

string RamCloud_server::getDynVar(string username, string filename);

| | |
|---|---|
| Parameters: | Username is a string containing the user name of the |
| | current user. |
| | Filename is a string containing the name of the file. |
| Return Value: | The dynamic variable in a string. |
| Example: | RamCloud_server *s; |
| | . . . |
| | String dyn = s->getDynVar(username,filename); |
| Requirements: | Include <RamCloud_server.h> |

The Physical Storage Functions include and will now be described:

| | | |
|---|---|---|
| chunk | getChunkNames | redup |
| encryptChunk | dedup | |

The chunk function is used to chunk the information and store it locally on the server.

vector<string> RamCloud_server::chunk(string data, char * filename,
char * filepath);

| | |
|---|---|
| Parameters: | data is a string that contains all the data that you would |
| | like chunked. |
| | filename is the file name of the original file. |
| | Filepath is the file path that you would the chunked files |
| | stored in. |
| Return Value: | A vector of strings containing the names of all the |
| | new chunks. |
| Example: | RamCloud_server *s; |
| | . . . |
| | string str = s->receiveData(ssl); |
| | string filepath = username; |
| | filepath += “\\”; |
| | s->chunk(str,(char *)filename.c_str( )); |
| | (char *)filepath.c_str( )); |
| Requirements: | Include <RamCloud_server.h> |

See also: new RamCloud_server

The encryptChunk function is used to encrypt a chunk.

string RamCloud_server::encryptChunk(string chunkName, int chunkNum);

| | |
|---|---|
| Parameters: | chunkName is a string containing the name of the chunk to |
| | be encrypted. |
| | chunkNum is an integer representing the number of the |
| | chunk. |
| Return Value: | A string containing the name of the encrypted chunk. |
| Example: | RamCloud_server *s; |
| | . . . |
| | string name=''''; |
| | for(int i=0;i<numChunks;i++){ |
| | name += encryptChunk(filename,i); |
| | } |
| Requirements: | Include <RamCloud_server.h> |

See also: new RamCloud_server and chunk

The getChunkNames function is used to determine all the chunk names of files stored locally on the server.

vector<string> RamCloud_server::getChunkNames(char * filename,
char * filepath);

| | |
|---|---|
| Parameters: | filename is the file name of the original file. |
| | Filepath is the file path where the chunks are located. |
| Return Value: | A vector of strings that contains all the chunk names in |
| | order from first to last. |
| Example: | RamCloud_server *s; |
| | . . . |
| | string filename = “myfile.txt”; |
| | string filepath = “Direct\\” |
| | vector<string> chunkNames = |
| | s->getChunkNames(filename.c_str( ),filepath.c_str( )); |
| Requirements: | Include <RamCloud_server.h> |

See also: new RamCloud_server, connectClient, chunk and encryptChunk

The dedup function deduplicates redundant data by finding matching files. It is for local directories only.

vector<string> RamCloud_server::dedup(string directory);

| | |
|---|---|
| Parameters: | directory is the directory you would like to have |
| | deduplicated. |
| Return Value: | A vector of strings that contains all the chunk names that |
| | were deduplicated. |
| Example: | RamCloud_server *s; |
| | . . . |
| | s->dedup(“Direct\\”); |
| Requirements: | Include <RamCloud_server.h> |

See also: new RamCloud_server, chunk and redup

The redup function reduplicates redundant data by looking at a duplicates file and regenerating the deduplicated ones.

| void RamCloud_server::redup(string directory); | |
|---|---|
| Parameters: | directory is the directory you would like to have |
| | reduplicated. |
| Return Value: | None. |
| Example: | RamCloud_server *s; |
| | . . . |
| | s->redup(“Direct\\”); |
| Requirements: | Include <RamCloud_server.h> |

See also: new RamCloud_server, chunk and dedup

The Cloud Storage Functions include and will now be described:

| | | |
|---|---|---|
| initAWS | deleteAWSObject | chunkAWS |
| createAWSBucket | deleteAWSBucket | getChunkNamesAWS |
| createAWSObject | listAWSBuckets | getFileAWS |
| retrieveAWSObject | listAWSObjects | |

Note that these functions were developed for use with Amazon Web Services. Similar functions for other cloud-based or network-based storage systems can be developed based on these functions.

The initAWS function initializes the Amazon Web Service functions for cloud storage.

bool RamCloud_server::initAWS(string accessKey, string secretKey);

| | |
|---|---|
| Parameters: | accessKey is a string containing the access key assigned to |
| | you by Amazon. |
| | secretKey is a string containing the secret access key |
| | assigned to you by Amazon. |
| Return Value: | None. |
| Example: | RamCloud_server *s; |
| | . . . |
| | s->initAWS(“AccessKey here”,“SecretAccessKey here”); |
| Requirements: | Include <RamCloud_server.h> |

See also: new RamCloud_server

The createAWSBucket function creates a new AWS bucket for you to store objects in. Buckets must be unique across all of the AWS therefore you need to come up with something special that no one has taken.

bool RamCloud_server:: createAWSBucket(string bucketName);

| | |
|---|---|
| Parameters: | bucketName is the name you would for your AWS bucket |
| | to be. |
| Return Value: | True upon success and false on failure. |
| Example: | RamCloud_server *s; |
| | . . . |
| | s->createAWSBucket(“RamCloud2011”); |
| Requirements: | Include <RamCloud_server.h> |

See also: initAWS

The createAWSObject function creates a new AWS object in the specified bucket with the specified name and contents.

bool RamCloud_server::createAWSObject(string bucketName, string
filename, string data);

| | |
|---|---|
| Parameters: | bucketName is the name of the AWS bucket your object |
| | will be in. |
| | filename is the name of the object you are creating. |
| | data is the data you want to be in the AWS object. |
| Return Value: | True upon success and false on failure. |
| Example: | RamCloud_server *s; |
| | . . . |
| | string data = “Hello World!”; |
| | s->createAWSObject(“RamCloud2011”,“hello.txt”,data); |
| Requirements: | Include <RamCloud_server.h> |

See also: initAWS and createAWSBucket

The retrieveAWSObject function retrieves the data from an AWS object stored in the cloud.

string RamCloud_server::retrieveAWSObject(string bucketName,
string filename);

| | |
|---|---|
| Parameters: | bucketName is the name of the AWS bucket your object |
| | is in. |
| | Filename is the name of the object you're retrieving. |
| Return Value: | A string containing the data from the object in the cloud |
| | if it exists otherwise it returns an empty string. |
| Example: | RamCloud_server *s; |
| | . . . |
| | string data = s->retrieveAWSObject |
| | (“RamCloud2011”,“hello.txt”); |
| Requirements: | Include <RamCloud_server.h> |

See also: initAWS and createAWSObject

The deleteAWSObject function deletes an AWS object in the specified bucket with the specified file name.

bool RamCloud_server::deleteAWSObject(string bucketName, string
filename);

| | |
|---|---|
| Parameters: | bucketName is the name of the AWS bucket your object |
| | is in. |
| | filename is the name of the object you're deleting. |
| Return Value: | True upon success and false on failure. |
| Example: | RamCloud_server *s; |
| | . . . |
| | s->deleteAWSObject(“RamCloud2011”,“hello.txt”); |
| Requirements: | Include <RamCloud_server.h> |

See also: initAWS and createAWSObject

The deleteAWSBucket function deletes an AWS bucket. The bucket must be completely empty before it can be deleted

bool RamCloud_server:: deleteAWSBucket(string bucketName);

| | |
|---|---|
| Parameters: | bucketName is the name of the AWS bucket you're |
| | deleting. |
| Return Value: | True on success and false on failure. |
| Example: | RamCloud_server *s; |
| | . . . |
| | s->deleteAWSObject(“RamCloud2011”,“hello.txt”); |
| Requirements: | Include <RamCloud_server.h> |

See also: initAWS, createAWSBucket and listAWSBuckets

The listAWSBuckets function lists all the AWS buckets you have on your AWS account.

vector<string> RamCloud_server::listAWSBuckets( );

| | |
|---|---|
| Parameters: | None. |
| Return Value: | A vector of strings containing the names of all the buckets |
| | registered to you AWS account. |
| Example: | RamCloud_server *s; |
| | . . . |
| | s->listAWSBuckets( ); |
| Requirements: | Include <RamCloud_server.h> |

See also: initAWS and createAWSBucket

The listAWSObjects function retrieves the list of all the objects in an AWS bucket that you specify.

vector<string> RamCloud_server::listAWSObjects(string bucketName);

| | |
|---|---|
| Parameters: | bucketName is tThe bucket name you would like to list |
| | objects from. |
| Return Value: | A vector of strings containing the names of all the |
| | objects in the specified bucket. |
| Example: | RamCloud_server *s; |
| | . . . |
| | s->listAWSObjects(“RamCloud2011”); |
| Requirements: | Include <RamCloud_server.h> |

See also: initAWS and createAWSObject

The chunkAWS function chunks the data you send in and places it in a bucket you specify. It does this using multiple calls to createAWSObject.

bool RamCloud_server::chunkAWS(string data, string bucketName, string
filename);

| | |
|---|---|
| Parameters: | data is the information you would like to send to the |
| | cloud. |
| | bucketName is the name of the bucket you want to place |
| | the data in. |
| | filename is the file name you will be using to refer to this |

group of chunks.

| | |
|---|---|
| Return Value: | True on success and false on failure |
| Example: | RamCloud_server *s; |
| | ... |
| | string str = s−>receiveData(ssl); |
| | string filepath = username; |
| | filepath += “\\”; |
| | s−>chunk(str,(char *)filename.c_str( ),(char |
| | *)filepath.c_str( )); |
| | if(s−>chunkAWS(str,“RamCloud2011”,filename)) |
| | cout << “it worked!\n”; |
| Requirements: | Include <RamCloud_server.h> |

See also: initAWS and createAWSObject

The getChunkNamesAWS function gets the names of all the chunks made for a specific filename. It does this my making a call to listAWSObjects and applying the chunk naming method to the filename and comparing it to the retrieved values.

vector<string> RamCloud_server::getChunkNamesAWS(string bucketName, string

filename);

| | |
|---|---|
| Parameters: | bucketName is the name of the bucket you want to place the data in. |
| | filename is the file name you used to refer to this group of chunks. |
| Return Value: | A vector of strings with the names of chunks in order from first to last |

that are on the server. If there were none then the string will be
empty.

| | |
|---|---|
| Example: | RamCloud_server *s; |
| | ... |
| | vector<string> names = |

s−>getChunkNamesAWS(“RamCloud2011”.filename);

| | |
|---|---|
| Requirements: | Include <RamCloud_server.h> |

See also: initAWS and listAWSObjects

The getFileAWS function is used to return a file to the user that has been chunked and stored on the cloud.

string RamCloud_server::getFileAWS(string bucketName, string
filename);

| | |
|---|---|
| Parameters: | bucketName is the name of the bucket the file will be |
| | found in. |
| | filename is the name of the file that the user is |
| | looking for. |
| Return Value: | A string containing all the encrypted data for the file. |
| Example: | RamCloud_server *s; |
| | ... |
| | string data = |
| | s−>getFileAWS(”RamCloud2011”,”myfile.txt”); |
| Requirements: | Include <RamCloud_server.h> |

The Administration Functions include and will now be described:

| | | |
|---|---|---|
| removeUser | listItems | setListingFlag |
| deleteUser | postItem | checkListingFlag |
| getPort | removeItem | getClientBucket |
| closePort | checkListingAvail | |

The removeUser function removes the current user from listings.

bool RamCloud_server::removeUser(string username);

| | |
|---|---|
| Parameters: | username is a string containing the username of the |
| | current user. |
| Return Value: | A Boolean that is true on a successful removal and false |
| | otherwise. |
| Example: | RamCloud_server *s; |
| | ... |
| | bool success = s−>removeUser(username); |
| Requirements: | Include <RamCloud_server.h> |

See also: deleteUser

The deleteUser function will delete the user while also deleting all of their files from AWS before calling removeUser.

int RamCloud_server::deleteUser(string username);

| | |
|---|---|
| Parameters: | username is a string containing the username of the |
| | current user. |
| Return Value: | An integer depending on any errors encountered. A 0 is a |
| | success, a 2 |

is failure to find the user's bucket, and a 3 is that a
file of that user is currently being accessed.

| | |
|---|---|
| Example: | RamCloud_server *s; |
| | ... |
| | int error = s−>deleteUser(username); |
| Requirements: | Include <RamCloud_server.h> |

See also: removeUser

The getPort function gets a port for the server to connect on.

| int RamCloud_server::getPort(SOCKET *fd); | |
|---|---|
| Parameters: | fd is the address of the socket. |
| Return Value: | An integer of the number of the port. |
| Example: | RamCloud_server *s; |
| | ... |
| | SOCKET fd; |
| | int port = s−>getPort(&fd); |
| Requirements: | Include <RamCloud_server.h> |

See also: closePort

The closePort function closes the port that the server was connected on.

| bool RamCloud_server::closePort(int port); | |
|---|---|
| Parameters: | port is an integer of the port connected on. |
| Return Value: | A Boolean true on success, and false on failure. |
| Example: | RamCloud_server *s; |
| | ... |
| | int port = s−>getPort(&fd); |
| | bool success = s−>closePort(port); |
| Requirements: | Include <RamCloud_server.h> |

See also: getPort

The listItems function finds all of the user's items.

vector<string> RamCloud_server::listItems(string username) ;

| | |
|---|---|
| Parameters: | wsername is a string containing the username of the |
| | current user. |
| Return Value: | A vector of strings containing all items that are in their |
| | listing. |
| Example: | RamCloud_server *s; |
| | ... |
| | vector<string> items = s−>listItems(username); |
| Requirements: | Include <RamCloud_server.h> |

See also: postItem and removeItem

The postItem function posts an item in the listings and in the records.

bool RamCloud_server::postItem(string username, string filename, string

origLen, string actLen);

| | |
|---|---|
| Parameters: | username is a string containing the username of the |
| | current user. |
| | filename is a string containing the name of the file to be |
| | posted. |
| | origLen is a string containing the original length of the |
| | file. |
| | actLen is a string containing the actual length of the file. |
| Return Value: | A Boolean true is a success, and false is a failure. |
| Example: | RamCloud_server *s; |
| | ... |
| | bool success = s−>postItem(username, filename, fileLen, |
| | actLen); |
| Requirements: | Include <RamCloud_server.h> |

See also: removeItem and listItems

The removeItem function removes an item in the listings and in the records.

bool RamCloud_server::removeItem(string username, string filename);

| | |
|---|---|
| Parameters: | username is a string containing the username of the |
| | current user. |
| | Filename is a string containing the name of the file to |
| | be removed. |
| Return Value: | A Boolean true is a success, and false is a failure. |
| Example: | RamCloud_server *s; |
| | ... |
| | bool success = s−>removeItem(username, filename); |
| Requirements: | Include <RamCloud_server.h> |

See also: postItem and listItems

The checkListingAvail function checks the availability of the given listing.

bool RamCloud_server::checkListingAvail(string username, string
filename);

| | |
|---|---|
| Parameters: | username is a string containing the username of the |
| | current user. |
| | filename is a string containing the name of the file |
| | to be posted. |
| Return Value: | A Boolean, true is a success, and false is a failure. |
| Example: | RamCloud_server *s; |
| | ... |
| | bool avail = |
| | s−>checkListingAvail(username,filename); |
| Requirements: | Include <RamCloud_server.h> |

See also: setListingFlag and checkListingFlag

The setListingFlag function sets the flag of the current listing to the desired flag. False will be returned only if the desired flag and the listing's flag are 1.

bool RamCloud_server::setListingFlag(string username, string filename,
int flag);

| | |
|---|---|
| Parameters: | username is a string containing the user name of the |
| | current user. |
| | filename is a string containing the name of the file to |
| | be posted. |
| | flag is an integer containing the desired flag. |
| Return Value: | A Boolean true is a success, and false is a failure. |
| Example: | RamCloud_server *s; |
| | ... |
| | bool avail = s−>setListingFlag(username, filename, 1); |
| Requirements: | Include <RamCloud_server.h> |

See also: checkListingAvail and checkListingFlag

The checkListingFlag function checks the flag of the current listing. False will be returned if the listing's flag is 1.

bool RamCloud_server::checkListingFlag(string username, string
filename);

| | |
|---|---|
| Parameters: | uername is a string containing the user name of the |
| | current user. |
| | filename is a string containing the name of the file |
| | to be posted. |
| Return Value: | A Boolean true is a success, and false is a failure. |
| Example: | RamCloud_server *s; |
| | ... |
| | bool avail = s−>checkListingFlag(username, |
| | filename); |
| Requirements: | Include <RamCloud_server.h> |

See also: checkListingAvail and setListingFlag

The getClientBucket function gets the name of the bucket of the current user.

string RamCloud_server::getClientBucket(string username);

| | |
|---|---|
| Parameters: | username is a string containing the username of the |
| | current user. |
| Return Value: | A string containing the bucketName of the current |
| | user. |
| Example: | RamCloud_server *s; |
| | ... |
| | string bucketName = s−>getClientBucket(username); |
| Requirements: | Include <RamCloud_server.h> |

The Readymade Functions include and will now be described:

| | | |
|---|---|---|
| getFile | listFiles | updateFile |
| putFile | deleteFile | |

The getFile function gets the file specified in the filename parameter by calling a thread function that connects to the client on a different port and retrieves the file.

void RamCloud_server::getFile(string username, string filename, SSL *
ssl);

| | |
|---|---|
| Parameters: | username is a string containing the username of the |
| | current user. |
| | filename is a string containing the name of the file to |
| | be retrieved. |
| | ssl is the SSL connection that a client is connected on. |
| Return Value: | None. |
| Example: | RamCloud_server *s; |
| | ... |
| | string username = “username”; |
| | string filename = “file.txt”; |
| | s−>getFile(username, filename, ssl); |
| Requirements: | Include <RamCloud_server.h> |

The putFile function puts the file specified in the filename parameter by calling a thread function that connects to the client of a different port and puts the file on the cloud.

void RamCloud_server::putFile(string username, string filename, int
fileLength, SSL * ssl);

| | |
|---|---|
| Parameters: | username is a string containing the username of the current |
| | user. |
| | filename is a string containing the name of the file to be |
| | retrieved. |
| | filelength is an integer that holds the length of the file. |
| | ssl is the SSL connection that a client is connected on. |
| Return Value: | None. |
| Example: | RamCloud_server *s; |
| | . . . |
| | string username; |
| | string filename; |
| | int length, |
| | s->putFile(username, filename, length, ssl); |
| Requirements: | Include <RamCloud_server.h> |

The listFiles function lists all the files currently on the cloud for the specified user by calling a thread function that connects to the client on a different port and then lists all files currently on the cloud.

int RamCloud_server::listFiles(string username,SSL * ssl);

| | |
|---|---|
| Parameters: | username is a string containing the username of the current |
| | user. |
| | ssl is the SSL connection that a client is connected on. |
| Return Value: | An integer if an error occurred, a success is 0. |
| Example: | RamCloud_server *s; |
| | . . . |
| | string username = “username”; |
| | s->listFiles(username, ssl); |
| Requirements: | Include <RamCloud_server.h> |

The deleteFile function deletes the file specified in the filename parameter by calling a thread function that connects to the client on a different port and then deletes the file from the listings and from the cloud.

int RamCloud_server::deleteFile(string username, string filename, SSL
* ssl);

| | |
|---|---|
| Parameters: | username is a string containing the username of the current |
| | user. |
| | filename is a string containing the name of the file to be |
| | deleted. |
| | ssl is the SSL connection that a client is connected on. |
| Return Value: | An integer if an error occurred, a success is 0. |
| Example: | RamCloud_server *s; |
| | . . . |
| | string username = “username”; |
| | string filename = “file.txt”; |
| | s->deleteFile(username, filename, ssl); |
| Requirements: | Include <RamCloud_server.h> |

The updateFile function updates the file specified in the filename parameter by calling a thread function that connects to the client on a different port and then updates the file in the listings and from the cloud.

int RamCloud_server::updateFile(string username, string filename, SSL *
* ssl);

| | |
|---|---|
| Parameters: | username is a string containing the user name of the current |
| | user. |
| | filename is a string containing the name of the file to be |
| | deleted. |
| | ssl is the ssl connection that a client is connected on. |
| Return Value: | An integer if an error occurred, a success is 0. |
| Example: | RamCloud_server *s; |
| | . . . |
| | string username = “username”; |
| | string filename = “file.txt”; |
| | s->updateFile(username, filename, ssl); |
| Requirements: | Include <RamCloud_server.h> |

The following description details the functions used in the Client SDK for the RamCloud product in accordance with the present invention. The Client was developed using Windows and only works in a Windows environment. Client libraries for other operating system can be developed based on the following functions. This SDK is used to compress, encrypt and transmit data, through SSL, to a secure server for cloud storage. The OpenSSL libraries need to be installed and included in the project under Project Properties->Linker->Additional Dependencies. The new client should be established using the RamCloud_client function before making any other function calls to a client object. The setKey function should be used before calling either encrypt or decrypt functions. The setServerInfo should be used before using the connectToServer, sendData, receiveData, or closeConnection functions. The Client Functions include and will now be described:

| | | | |
|---|---|---|---|
| compression | RamCloud_client | closeConnection | sendHeader |
| decompression | setServerInfo | getResult | putFile |
| encrypt | sendData | createNewUser | getFile |
| decrypt | receiveData | loginUser | getKey |
| setKey | connectToServer | receiveHeader | encryptKey |

The compression function is used to compress data before it is encrypted. You must pass in all the parameters. Use fopen_s to open the files.

int RamCloud_client::compression(FILE * source, FILE * dest);

| | |
|---|---|
| Parameters: | source is a pointer to a file from which uncompressed data |
| | will be read. |
| | dest is a pointer to a file that will be written to and will |
| | contain the compressed data. |
| Return Value: | Shows whether the function completed successfully (0) or |
| | failed (>0). |
| Example: | RamCloud_client * c; |
| | . . . |
| | FILE * s, *d; |
| | fopen_s(&s, ″myfile.txt″,″rb″); |
| | fopen_s(&d, ″mycompressedfile.txt″,″wb″); |
| | c->compression(s,d); |
| Requirements: | Include <RamCloud_client.h> |
| See also: | new RamCloud_client |

The compression function is used to compress data before it is encrypted. You must pass in all the parameters. Use fopen_s to open the files.

string RamCloud_client::compression(char * data, int * len);

| | |
|---|---|
| Parameters: | data is a character array containing the data to be |
| | compressed. |
| | len is an integer containing the length of the data to be |
| | compressed. |
| Return Value: | The compressed data. |
| Example: | RamCloud_client * c; |
| | . . . |
| | FILE * s, *d; |
| | char * data = “hello world”; |
| | int len = data.length( ); |
| | String compressedData; |
| | compressedData = c->compression(s,l); |
| Requirements: | Include <RamCloud_client.h> |

See also: new RamCloud_client

The decompression function is used to decompress data after it has been decrypted. You must pass in all the parameters. Use fopen_s to open the file.

int RamCloud_client::decompression(FILE * source,FILE * dest);

| | |
|---|---|
| Parameters: | source is a pointer to a file from which compressed data |
| | will be read. |
| | dest is a pointer to a file that will be written to and will |
| | contain the decompressed data. |
| Return Value: | An integer that shows whether the function completed |
| | successfully(0) or failed (>0). |
| Example: | RamCloud_client * c; |
| | . . . |
| | FILE * s, *d; |
| | fopen_s(&s, ″mycompressedfile.txt″,″wb″); |
| | fopen_s(&d, ″myfile.txt″,″rb″); |
| | c->decompression(s,d); |
| Requirements: | Include <RamCloud_client.h> |

See also: new RamCloud_client

The decompression function is used to decompress data after it has been decrypted. You must pass in all the parameters.

string RamCloud_client::decompression(char * data, int * len, unsigned
long originalLen);

| | |
|---|---|
| Parameters: | data is a character array containing the data to be |
| | decompressed. |
| | len is an integer containing the length of the data to be |
| | decompressed. |
| | originalLength holds the original length of the data before |
| | compression. |
| Return Value: | A string that holds the decompressed data. |
| Example: | RamCloud_client * c; |
| | . . . |
| | string decompressedData; |
| | decompressedData=c->decompression(data,data.length( ), |
| | originalLength); |
| Requirements: | Include <RamCloud_client.h> |

See also: new RamCloud_client

The encrypt function encrypts an array of characters that have been read from a file or produced by the compression function. The returned string is ready to be sent to the server.

string RamCloud_client::encrypt(char * data, int *dLen);

| | |
|---|---|
| Parameters: | data is an array of characters that will encrypted using the |
| | dynamic key. |
| | dLen is a pointer to the length of the data that will contain |
| | the length of the new string. |
| Return Value: | A string containing the encrypted data. This string is ready |
| | to be sent to the server. |
| Example: | RamCloud_client * c; |
| | . . . |
| | string data = ″Hello World!″; |
| | int len = data.length( ); |
| | string cryptText = c->encrypt((char *)data.c _str( ), &len); |
| Requirements: | Include <RamCloud_client.h> |

See also: new RamCloud_client and setKey

The encryptKey function sets up the encryption for the user key. It should not be called by the application.

int RamCloud_client::encryptKey( );

| | |
|---|---|
| Parameters: | None. |
| Return Value: | An integer containing the error code. |
| Example: | RamCloud_client * c; |
| | . . . |
| | string key = ″Hello World!″; |
| | int len = data.length( ); |
| | int error = c->encryptKey( ); |
| | string cryptText = c->encrypt((char *)data.c_str( ), &len); |
| Requirements: | Include <RamCloud_client.h> |

See also: new RamCloud_client and setKey

The decrypt function decrypts data that was encrypted before-hand. If the key or contents has changed the decrypted information will not be correct.

string RamCloud_client::decrypt(char * data, int *dLen);

| | |
|---|---|
| Parameters: | data is an array of characters that will decrypted using the |
| | dynamic key. |
| | dLen is a pointer to the length of the data that will contain |
| | the length of the new string. |
| Return Value: | A string containing the decrypted data. Decompressing this |
| | string gives you the original data. |
| Example: | RamCloud_client * c; |
| | . . . |
| | string data = ″Hello World!″; |
| | int len = data.length( ); |
| | string cryptText = c->encrypt((char *)data.c_str( ), &len); |
| | string plainText = c->decrypt((char *)cryptText.c_str( ), |
| | &len); |
| Requirements: | Include <RamCloud_client.h> |

See also: new RamCloud_client and setKey

The setKey function is used to set the key for encryption and decryption. The dynamic variable is used in combination with the user key which is hidden from the client except during creation and recovery.

int RamCloud_client::setKey(char * dynamicVariable = ″″);

| | |
|---|---|
| Parameters: | dynamicVariable is a character array that can contain |
| | anything you want to add to the key to make it more |
| | difficult to break. |
| Return Value: | 0 on a success and >0 on failure. |
| Example: | RamCloud_client * c; |
| | . . . |
| | c->setKey(“UsedToMakeEachKeyDifferent″); |
| Requirements: | Include <RamCloud_client.h> |

See also: new RamCloud_client

The new RamCloud_client function loads the socket and SSL libraries to prepare for setServerInfo and connectToServer.

| RamCloud_client::RamCloud_client( ); | |
|---|---|
| Parameters: | None. |
| Return Value: | None. |
| Example: | RamCloud_client * c; |
| | . . . |
| | c = new RamCloud_client( ); |
| Requirements: | Include <RamCloud_client.h> |

See also: setServerInfo and connectToServer

The setServerInfo function sets the servers info for the SSL connection.

void RamCloud_client::setServerInfo(char * address, unsigned short
portNum);

| | |
|---|---|
| Parameters: | address is the IP address of the server. |
| | portNum is the port that the client will connect on. |
| Return Value: | None. |
| Example: | RamCloud_client * c; |
| | . . . |
| | c->setServerInfo(″10.2.33.59″,443); //sets up information |
| | for connecting to the server |
| Requirements: | Include <RamCloud_client.h> |

See also: new RamCloud_client

The sendData function sends the specified data(s) to the server using an SSL connection.

int RamCloud_client::sendData(void * data, int length);

| | |
|---|---|
| Parameters: | data is a buffer that will contain data being sent to the |
| | server. |
| | length is the length of the character array, or amount of |
| | data that the client wants to send. |
| Return Value: | The number of bytes that were written to the server |
| Example: | RamCloud_client * c; |
| | . . . |
| | string str = ″Hello World!″; |
| | c->sendData((void *)str.c_str( ), str.length( )); |
| Requirements: | Include <RamCloud_client.h> |

See also: new RamCloud_client and setServerInfo

The receiveData function receives data from the server specified in setServerInfo. The data will be in exactly the same format that it was sent.

string RamCloud_client::receiveData( );

| | |
|---|---|
| Parameters: | None. |
| Return Value: | The returned string contains the data sent by the server. |
| Example: | RamCloud_client * c; |
| | . . . |
| | string str = c->receiveData( ); |
| Requirements: | Include <RamCloud_client.h> |

See also: new RamCloud_client and setServerInfo

The connectToServer function connects to the server specified in setServerInfo.

| int RamCloud_client::connectToServer( ); | |
|---|---|
| Parameters: | None. |
| Return Value: | 0 on a success and 1 on a fail. |
| Example: | RamCloud_client * c; |
| | . . . |
| | c->connectToServer( ); |
| Requirements: | Include <RamCloud_client.h> |

See also: new RamCloud_client and setServerInfo

The closeConnection function closes the connection to the specified server in setServerInfo.

void RamCloud_client::closeConnection( );

| | |
|---|---|
| Parameters: | None. |
| Return Value: | None. |
| Example: | RamCloud_client * c; |
| | . . . |
| | c->closeConnection( ); |
| Requirements: | Include <RamCloud_client.h> |

See also: new RamCloud_client, connectToServer and setServerInfo

The getResult function is used to determine how the server reacted to the header information from a file. It should be called after sending the header and before the actual data.

int RamCloud_client::getResult( );

| | |
|---|---|
| Parameters: | None. |
| Return Value: | An integer that tells whether the server succeeded in storing |
| | the file (0) or if there was an error (>0). |
| Example: | RamCloud_client * c; |
| | . . . |
| | c->getResult( ); |
| Requirements: | Include <RamCloud_client.h> |

See also: new RamCloud_client, connectToServer and setServerInfo

The createNewUser function attempts to create a new user account on the server side. It sends over relevant information needed to create the user account. It also receives the user key on success, encrypts, and saves it.

bool RamCloud_client::createNewUser(string username);

| | |
|---|---|
| Parameters: | None. |
| Return Value: | True if the client successfully created a new user name |
| | on the server. |
| Example: | RamCloud_client * c; |
| | . . . |
| | c->connectToServer( ); |
| | c->createNewUser(“Mat”); |
| Requirements: | Include <RamCloud_client.h> |

See also: new RamCloud_client, connectToServer and setServerInfo

The loginUser function attempts to log in to a user account already on the server.

bool RamCloud_client::loginUser(string username);

| | |
|---|---|
| Parameters: | username is the name used to identify a specific user. |
| Return Value: | True if the client successfully logged into the server. |
| Example: | RamCloud_client * c; |
| | . . . |
| | c->connectToServer( ); |
| | c->loginUser(“Mat”); |
| Requirements: | Include <RamCloud_client.h> |

See also: new RamCloud_client, connectToServer and setServerInfo

The receiveHeader function waits for the server to send it a header file in response to some request.

RamCloud_header *RamCloud_client::receiveHeader( );

| | |
|---|---|
| Parameters: | None. |
| Return Value: | A RamCloud_header struct containing information |
| | useful to the client. |
| Example: | RamCloud_client * c; |
| | . . . |
| | RamCloud_header *h = new RamCloud_header( ); |
| | H = c->receiveHeader( ); |
| Requirements: | Include <RamCloud_client.h> |

See also: new RamCloud_client, connectToServer and setServerInfo

The sendHeader function sends a RamCloud_header struct containing useful information.

| | int *RamCloud_client::sendHeader(RamCloud_header * h); | |
|---|---|---|
| | Parameters: | h is a RamCloud_header struct containing useful information to be |
| sent. | | |
| | Return Value: | An integer with values dependent on a success or failure. |
| | Example: | RamCloud_client * c; |
| | | . . . |
| | | RamCloud_header *h = new RamCloud_header( ); |
| | | int res = c->sendHeader(h); |
| | Requirements: | Include <RamCloud_client.h> |

See also: new RamCloud_client, connectToServer and setServerInfo

The getFile function gets the file specified in the filename parameter. This function is used along-side the server's getFile function and should only be used if the program is using the ready-made capabilities.

bool RamCloud_client::getFile(string filename, string username);

| | |
|---|---|
| Parameters: | filename is a string containing the name of the file to |
| | be retrieved. |
| | username is a string containing the username of the |
| | current user. |
| Return Value: | Boolean, true is a success and false is a failure. |
| Example: | RamCloud_client *c; |
| | . . . |
| | string username = “username”; |
| | string filename = “file.txt”; |
| | bool result = c->getFile(filename, username); |

Requirements: Include <RamCloud_client.h>

The putFile function puts the file specified in the filename parameter on the cloud. This function is used along-side the server's putFile function and should only be used if the program is using the ready-made capabilities.

bool RamCloud_client::putFile(string filename, string username);

| | |
|---|---|
| Parameters: | username is a string containing the username of the |
| | current user. |
| | filename is a string containing the name of the file to |
| | be retrieved. |
| Return Value: | Boolean, true is a success and false is a failure. |
| Example: | RamCloud_client *c; |
| | . . . |
| | string username; |
| | string filename; |
| | bool result = c->putFile(filename, username); |

Requirements: Include <RamCloud_client.h>

The deleteFile function deletes the file specified in the filename parameter on the cloud. This function is used along-side the server's deleteFile function and should only be used if the program is using the ready-made capabilities.

| | (pthread_t, HANDLE) RamCloud_client::deleteFile(string filename, string | |
|---|---|---|
| username); | | |
| | Parameters: | username is a string containing the username of the current user. |
| | | filename is a string containing the name of the file to be deleted. |
| | Return Value: | a HANDLE on windows and pthread_t on Linux/Android for use |
| | | with the updateFile function. Otherwise it should be ignored and |
| | | messageHandler should be checked for success. |
| | Example: | RamCloud_client *c; |
| | | . . . |
| | | string username; |
| | | string filename; |
| | | bool result = c->deleteFile(filename, username); |

Requirements: Include <RamCloud_client.h>

The updateFile function updates the file specified in the filename parameter on the cloud. This function is used along-side the server's updateFile function and should only be used if the program is using the ready-made capabilities

bool RamCloud_client::updateFile(string filename, string username);

| | |
|---|---|
| Parameters: | username is a string containing the username of the |
| | current user. |
| | filename is a string containing the name of the file to |
| | be retrieved. |
| Return Value: | Boolean, true is a success and false is a failure. |
| Example: | RamCloud_client *c; |
| | . . . |
| | string username; |
| | string filename; |
| | bool result = c->deleteFile(filename, username); |

Requirements: Include <RamCloud_client.h>

The messageHandler function is used to get messages from other functions while not interrupting the current activity.

string messageHandler( );

| | |
|---|---|
| Parameters: | None. |
| Return Value: | A string containing the latest message created by the SDK. |
| Example: | RamCloud_client *c; |
| | . . . |
| | string msg = c->messageHandler( ); |
| | cout << msg << endl; |
| Requirements: | Include <RamCloud_client.h> |

See also: pushMessage(string msg);

The pushMessage function is used to push a message to the messageHandler for retrieval.

| void pushMessage(string msg); | |
|---|---|
| Parameters: | msg is the message you would like to push to the |
| | messageHandler. |
| Return Value: | None. |
| Example: | RamCloud_client *c; |
| | . . . |
| | string msg = “Hello world!”; |
| | c->pushmessage(msg); |
| Requirements: | Include <RamCloud_client.h> |

See also: pushMessage(string msg)

The getKey function gets the users key from the server in case it was lost. The key is not actually exposed to the application, just placed in a secure location for future use.

bool RamCloud_client::getKey(string username);

| | |
|---|---|
| Parameters: | username is the name used to identify a specific user. |
| Return Value: | True if the client successfully got back its key. |
| Example: | RamCloud_client * c; |
| | . . . |
| | if(c->getKey(“Mat”)) |
| | cout << “The key was recovered. . . \n”; |
| Requirements: | Include <RamCloud_client.h> |

See also: new RamCloud_client, connectToServer and setServerInfo.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. A method for securely saving a data on a data storage using a server device having a one or more processors and one or more communication interfaces, the method comprising the steps of:
receiving a file from a user device via the one or more communication interfaces, wherein the file contains an encrypted data and has a file name;
splitting the encrypted data into two or more encrypted data chunks having a specified size;
assigning a chunk number to each of the two or more encrypted data chunks;
saving each of the two or more encrypted data chunks in a chunk file having a chunk file name comprising a combination of the file name and the chunk number;
encrypting each chunk file name; and
sending each chunk file having the encrypted chunk file name to the data storage via the one or more interfaces.

2. The method as recited in claim 1, further comprising the steps of:
generating an encryption/decryption key for the user device or a user of the user device; and
providing the encryption/decryption key to the user device.

3. The method as recited in claim 1, wherein the encrypted data was compressed prior to being encrypted.

4. The method as recited in claim 1, further comprising the step of saving a meta data about the received file.

5. The method as recited in claim 4, wherein the meta data comprises a length of the received file.

6. The method as recited in claim 1, wherein the specified size comprises 64 KB.

7. The method as recited in claim 1, further comprising the step of initializing the server device using one or more parameters.

8. The method as recited in claim 1, further comprising the step of accepting a secure connection from the user device via the one or more interfaces.

9. The method as recited in claim 1, further comprising the step of establishing a connection with the data storage via the one or more interfaces.

10. The method as recited in claim 1, wherein the data storage comprises a remote data storage device, a network data storage device or a cloud data storage server.

11. The method as recited in claim 1, wherein the user device comprises a mobile phone, a mobile computing device, a computer, a workstation, a laptop, a tablet, a handheld computing device, a handheld communications device, a personal data assistant, an entertainment device or a data storage device.

12. The method as recited in claim 1, further comprising the step of creating an account for a user.

13. The method as recited in claim 1, further comprising the steps of:
receiving a login data from the user device; and
authenticating the login data.

14. The method as recited in claim 1, further comprising the step of determining whether another file having the file name has been received.

15. The method as recited in claim 1, further comprising the step of sending a message to the user device that the file cannot be accepted because the file name has already been used.

16. The method as recited in claim 1, wherein the user device creates the encrypted data using an encryption/decryption key based on a user key and a dynamic variable.

17. The method as recited in claim 16, wherein the dynamic variable is based on one or more characteristics of the file.

18. The method as recited in claim 16, wherein the user device compresses the data prior to encrypting the data.

19. The method as recited in claim 16, wherein the encryption/decryption key is destroyed after it is used.

20. A method for retrieving a data on a data storage using a server device having a one or more processors and one or more communication interfaces, the method comprising the steps of:
receiving a request for a file from a user device via the one or more communication interfaces, wherein the file contains an encrypted data and has a file name;
retrieving two or more chunk file names associated with the file;
encrypting each chunk file name;
retrieving each chunk file using the encrypted chunk file names from the data storage via the one or more interfaces, wherein each chunk file contains an encrypted data chunk having a specified size;
combining the encrypted data chunks into the file having the file name; and
sending the file to the user device via the one or more communication interfaces.

21. The method as recited in claim 20, further comprising the step of retrieving a meta data about the file.

22. The method as recited in claim 21, wherein the meta data comprises a length of the file.

23. The method as recited in claim 20, wherein the specified size comprises 64 KB.

24. The method as recited in claim 20, further comprising the step of accepting a secure connection from the user device via the one or more interfaces.

25. The method as recited in claim 20, further comprising the step of establishing a connection with the data storage via the one or more interfaces.

26. The method as recited in claim 20, wherein the data storage comprises a remote data storage device, a network data storage device or a cloud data storage server.

27. The method as recited in claim 20, wherein the user device comprises a mobile phone, a mobile computing device, a computer, a workstation, a laptop, a tablet, a handheld computing device, a handheld communications device, a personal data assistant, an entertainment device or a data storage device.

28. The method as recited in claim 20, wherein the user device decrypts the encrypted data using an encryption/decryption key based on a user key and a dynamic variable.

29. The method as recited in claim 28, wherein the dynamic variable is based on one or more characteristics of the file.

30. The method as recited in claim 28, wherein the user device decompresses the data after decrypting the encrypted data.

31. The method as recited in claim 28, wherein the encryption/decryption key is destroyed after it is used.

32. An apparatus for securely saving a data on a data storage comprising:
one or more interfaces;
one or more processors communicably coupled to the one or more interfaces; and
wherein the one or more processors:
receive a file from a user device via the one or more communication interfaces, wherein the file contains an encrypted data and has a file name,
split the encrypted data into two or more encrypted data chunks having a specified size,
assign a chunk number to each of the two or more encrypted data chunks,
save each of the two or more encrypted data chunks in a chunk file having a chunk file name comprising a combination of the file name and the chunk number,
encrypt each chunk file name, and
send each chunk file having the encrypted chunk file name to the data storage via the one or more interfaces.

33. The apparatus as recited in claim 32, wherein the one or more processors further:
generate an encryption/decryption key for the user device or a user of the user device; and
provide the encryption/decryption key to the user device.

34. The apparatus as recited in claim 32, wherein the encrypted data was compressed prior to being encrypted.

35. The apparatus as recited in claim 32, wherein the one or more processors further save a meta data about the received file.

36. The apparatus as recited in claim 35, wherein the meta data comprises a length of the received file.

37. The apparatus as recited in claim 32, wherein the specified size comprises 64 KB.

38. The apparatus as recited in claim 32, wherein the one or more processors further initialize the server device using one or more parameters.

39. The apparatus as recited in claim 32, wherein the one or more processors further accept a secure connection from the user device via the one or more interfaces.

40. The apparatus as recited in claim 32, wherein the one or more processors further establish a connection with the data storage via the one or more interfaces.

41. The apparatus as recited in claim 32, wherein the data storage comprises a remote data storage device, a network data storage device or a cloud data storage server.

42. The apparatus as recited in claim 32, wherein the user device comprises a mobile phone, a mobile computing device, a computer, a workstation, a laptop, a tablet, a handheld computing device, a handheld communications device, a personal data assistant, an entertainment device or a data storage device.

43. The apparatus as recited in claim 32, wherein the one or more processors further create an account for a user.

44. The apparatus as recited in claim 32, wherein the one or more processors further:
receive a login data from the user device; and
authenticate the login data.

45. The apparatus as recited in claim 32, wherein the one or more processors further determine whether another file having the file name has been received.

46. The apparatus as recited in claim 32, wherein the one or more processors further send a message to the user device that the file cannot be accepted because the file name has already been used.

47. The apparatus as recited in claim 32, wherein the user device creates the encrypted data using an encryption/decryption key based on a user key and a dynamic variable.

48. The apparatus as recited in claim 47, wherein the dynamic variable is based on one or more characteristics of the file.

49. The apparatus as recited in claim 47, wherein the user device compresses the data prior to encrypting the data.

50. The apparatus as recited in claim 47, wherein the encryption/decryption key is destroyed after it is used.

51. An apparatus for retrieving a data on a data storage comprising:
one or more interfaces;
one or more processors communicably coupled to the one or more interfaces; and
wherein the one or more processors:
receive a request for a file from a user device via the one or more communication interfaces, wherein the file contains an encrypted data and has a file name,
retrieve two or more chunk file names associated with the file,
encrypt each chunk file name,
retrieve each chunk file using the encrypted chunk file names from the data storage via the one or more interfaces, wherein each chunk file contains an encrypted data chunk having a specified size,
combine the encrypted data chunks into the file having the file name, and
send the file to the user device via the one or more communication interfaces.

52. The apparatus as recited in claim 51, wherein the one or more processors further retrieve a meta data about the file.

53. The apparatus as recited in claim 52, wherein the meta data comprises a length of the file.

54. The apparatus as recited in claim 51, wherein the specified size comprises 64 KB.

55. The apparatus as recited in claim 51, wherein the one or more processors further accept a secure connection from the user device via the one or more interfaces.

56. The apparatus as recited in claim 51, wherein the one or more processors further establish a connection with the data storage via the one or more interfaces.

57. The apparatus as recited in claim 51, wherein the data storage comprises a remote data storage device, a network data storage device or a cloud data storage server.

58. The apparatus as recited in claim 51, wherein the user device comprises a mobile phone, a mobile computing device, a computer, a workstation, a laptop, a tablet, a handheld computing device, a handheld communications device, a personal data assistant, an entertainment device or a data storage device.

59. The apparatus as recited in claim 51, wherein the user device decrypts the encrypted data using an encryption/decryption key based on a user key and a dynamic variable.

60. The apparatus as recited in claim 59, wherein the dynamic variable is based on one or more characteristics of the file.

61. The apparatus as recited in claim 59, wherein the user device decompresses the data after decrypting the encrypted data.

62. The apparatus as recited in claim 59, wherein the encryption/decryption key is destroyed after it is used.

63. A system for securely saving a data comprising:
one or more user devices;
a data storage;
one or more networks; and
a server device communicably coupled to the one or more user devices and the data storage via the one or more networks, wherein the server device:
receives a file from the one or more user devices, wherein the file contains an encrypted data and has a file name,
splits the encrypted data into two or more encrypted data chunks having a specified size,
assigns a chunk number to each of the two or more encrypted data chunks,
saves each of the two or more encrypted data chunks in a chunk file having a chunk file name comprising a combination of the file name and the chunk number,
encrypts each chunk file name, and
sends each chunk file having the encrypted chunk file name to the data storage.

64. The system as recited in claim 63, wherein the one or more processors further:
generate an encryption/decryption key for the user device or a user of the user device; and
provide the encryption/decryption key to the user device.

65. The system as recited in claim 63, wherein the encrypted data was compressed prior to being encrypted.

66. The system as recited in claim 63, wherein the one or more processors further save a meta data about the received file.

67. The system as recited in claim 66, wherein the meta data comprises a length of the received file.

68. The system as recited in claim 63, wherein the specified size comprises 64 KB.

69. The system as recited in claim 63, wherein the one or more processors further initialize the server device using one or more parameters.

70. The system as recited in claim 63, wherein the one or more processors further accept a secure connection from the user device via the one or more interfaces.

71. The system as recited in claim 63, wherein the one or more processors further establish a connection with the data storage via the one or more interfaces.

72. The system as recited in claim 63, wherein the data storage comprises a remote data storage device, a network data storage device or a cloud data storage server.

73. The system as recited in claim 63, wherein the user device comprises a mobile phone, a mobile computing device, a computer, a workstation, a laptop, a tablet, a handheld computing device, a handheld communications device, a personal data assistant, an entertainment device or a data storage device.

74. The system as recited in claim 63, wherein the one or more processors further create an account for a user.

75. The system as recited in claim 63, wherein the one or more processors further:
receive a login data from the user device; and
authenticate the login data.

76. The system as recited in claim 63, wherein the one or more processors further determine whether another file having the file name has been received.

77. The system as recited in claim 63, wherein the one or more processors further send a message to the user device that the file cannot be accepted because the file name has already been used.

78. The system as recited in claim 63, wherein the user device creates the encrypted data using an encryption/decryption key based on a user key and a dynamic variable.

79. The system as recited in claim 78, wherein the dynamic variable is based on one or more characteristics of the file.

80. The system as recited in claim 78, wherein the user device compresses the data prior to encrypting the data.

81. The system as recited in claim 78, wherein the encryption/decryption key is destroyed after it is used.

82. A system for securely retrieving a data comprising:
one or more user devices;
a data storage;
one or more networks; and
a server device communicably coupled to the one or more user devices and the data storage via the one or more networks, wherein the server device:
receives a request for a file from a user device, wherein the file contains an encrypted data and has a file name,
retrieves two or more chunk file names associated with the file,
encrypts each chunk file name,
retrieves each chunk file using the encrypted chunk file names from the data storage, wherein each chunk file contains an encrypted data chunk having a specified size,
combines the encrypted data chunks into the file having the file name, and
sends the file to the user device via the one or more communication interfaces.

83. The system as recited in claim 82, wherein the one or more processors further retrieve a meta data about the file.

84. The system as recited in claim 83, wherein the meta data comprises a length of the file.

85. The system as recited in claim 82, wherein the specified size comprises 64 KB.

86. The system as recited in claim 82, wherein the one or more processors further accept a secure connection from the user device via the one or more interfaces.

87. The system as recited in claim 82, wherein the one or more processors further establish a connection with the data storage via the one or more interfaces.

88. The system as recited in claim 82, wherein the data storage comprises a remote data storage device, a network data storage device or a cloud data storage server.

89. The system as recited in claim 82, wherein the user device comprises a mobile phone, a mobile computing device, a computer, a workstation, a laptop, a tablet, a handheld computing device, a handheld communications device, a personal data assistant, an entertainment device or a data storage device.

90. The system as recited in claim 82, wherein the user device decrypts the encrypted data using an encryption/decryption key based on a user key and a dynamic variable.

91. The system as recited in claim 90, wherein the dynamic variable is based on one or more characteristics of the file.

92. The system as recited in claim 90, wherein the user device decompresses the data after decrypting the encrypted data.

93. The system as recited in claim 90, wherein the encryption/decryption key is destroyed after it is used.
